(19) United States
(12) Patent Application Publication
(10) Pub. No.: US 2026/0323746 A1
(43) Pub. Date: Oct. 15, 2026

(54) Supporting Multiple Indirect Paths in Multi-Path Relaying

(71) Applicant: Apple Inc., Cupertino, CA (US)

(72) Inventors: Zhibin WU, Los Altos, CA (US); Alexander SIROTKIN, Hod Hasharon (IL); Fangli XU, Beijing (CN); Haijing HU, Los Gatos, CA (US); Naveen Kumar R PALLE VENKATA, San Diego, CA (US); Peng CHENG, Beijing (CN); Ping-Heng KUO, London (GB); Ralf ROSSBACH, Munich (DE); Yuqin CHEN, Beijing (CN)

(21) Appl. No.: 19/484,575

(22) PCT Filed: May 18, 2023
(86) PCT No.: PCT/CN2023/095078

§ 371 Date: Nov. 14, 2025

(51) Int. Cl. H04W 76/15; H04W 72/40; H04W 76/27

(52) U.S. Cl. CPC H04W 76/15; H04W 72/40; H04W 76/27

(57) ABSTRACT

A user equipment (UE) configured to receive a radio resource control (RRC) configuration for UE-to-network (U2N) relay operations including at least two indirect paths, wherein a first indirect path is configured with a first relay UE via a first sidelink (SL) and a second indirect path is configured with a second relay UE via a second SL and determine a primary path as either the first indirect path or the second indirect path.

### TECHNICAL FIELD

The present disclosure generally relates to wireless communication, and in particular, to supporting multiple indirect paths in multi-path relaying.

### BACKGROUND INFORMATION

A user equipment (UE) may be configured with multiple communication links. For example, the UE may receive a signal from a cell of a corresponding network over a downlink (DL) and may transmit a signal to the cell of the corresponding network over an uplink (UL). The UE may also be configured to communicate with a further UE via a sidelink (SL). The term sidelink refers to a communication link that may be utilized for device-to-device (D2D) communication.

The SL may be used for relay assistance to forward data/signals between a network and a remote UE that is out of range of the network and/or has poor network coverage. For example, a relay UE that is within range of the network and/or has good network coverage may relay data/signals between the network and the remote UE via the SL connection with the remote UE. A Layer 2 (L2) UE-to-NW relay forwards received signals to the destination after successful decoding/encoding and demodulation/modulation of the signals, while still maintaining an end-to-end L2 connection between the remote UE and network.

A direct network connection (not employing the L2 relay) may be referred to as a direct network path for the UE, while the network connection employing the L2 relay over SL may be referred to as an indirect network path for the (remote) UE. In Rel- 18 of the 3GPP standards, operations will be supported for multi-path communications for the case of one direct path and one indirect path. In future releases (e.g., Rel-19), operations may be supported for multi-path communications for the case of two indirect paths (Case 1), one direct path and two indirect paths (Case 2), and/or one direct path and more than two indirect paths.

### SUMMARY

Some exemplary embodiments are related to a method performed by a user equipment (UE). The method includes receiving a radio resource control (RRC) configuration for UE-to-network (U2N) relay operations including at least two indirect paths, wherein a first indirect path is configured with a first relay UE via a first sidelink (SL) and a second indirect path is configured with a second relay UE via a second SL and determining a primary path as either the first indirect path or the second indirect path.

Other exemplary embodiments are related to a method performed by a user equipment (UE). The method includes receiving a radio resource control (RRC) configuration for UE-to-network (U2N) relay operations including at least two indirect paths wherein a first indirect path is configured with a first relay UE via a first sidelink (SL) and a second indirect path is configured with a second relay UE via a second SL, the RRC configuration including a first radio link control (RLC) entity associated with the first relay UE and a second RLC entity associated with the second relay UE and selecting either the first indirect path or the second indirect path for uplink (UL) traffic by indicating an identifier for either the first relay UE or the second relay UE in a packet data convergence protocol (PDCP) header added by a PDCP entity.

Still further exemplary embodiments are related to a method performed by a user equipment (UE). The method includes receiving a radio resource control (RRC) configuration for UE-to-network (U2N) relay operations including at least two indirect paths wherein a first indirect path is configured with a first relay UE via a first sidelink (SL) and a second indirect path is configured with a second relay UE via a second SL, the RRC configuration including a common configuration for both the first and second indirect paths and using SL groupcast operations or SL broadcast operations by a single SL radio link control (RLC) entity to transmit packets to the first and second relay UEs.

Additional exemplary embodiments are related to a method performed by a user equipment (UE). The method includes receiving a radio resource control (RRC) configuration for UE-to-network (U2N) relay operations including an indirect path, wherein the indirect path is configured with a relay UE via a sidelink (SL), the RRC configuration including an indication of whether carrier aggregation (CA) duplication in a sidelink relay adaptation protocol (SRAP) layer is enabled and when CA duplication in the SRAP layer is enabled, adding a sequence number (SN) in a SRAP header so that duplicate SRAP protocol data units (PDUs) received in different component carriers can be detected.

Further exemplary embodiments are related to a method performed by a user equipment (UE). The method includes receiving a radio resource control (RRC) configuration for UE-to-network (U2N) relay operations including an indirect path in which the UE is a relay UE for a remote UE via a sidelink (SL) and using SL groupcast operations or SL broadcast operations by a SL radio link control (RLC) entity to transmit packets to and receive packets from the remote UE.

More exemplary embodiments are related to a method performed by a user equipment (UE). The method includes receiving a radio resource control (RRC) configuration for UE-to-network (U2N) relay operations including an indirect path in which the UE is a relay UE for a remote UE via a sidelink (SL), the RRC configuration including an indication of whether carrier aggregation (CA) duplication in a sidelink relay adaptation protocol (SRAP) layer is enabled and when CA duplication in the SRAP layer is enabled, receiving a duplicate SRAP protocol data unit (PDUs) including a sequence number (SN) in a SRAP header.

### BRIEF DESCRIPTION OF THE DRAWINGS

FIG. 1a shows a diagram of a first multi-path relay scenario for a remote user equipment (UE) comprising one direct path and one indirect path according to various exemplary embodiments.

FIG. 1b shows a diagram of a second multi-path relay scenario for the remote UE comprising two indirect paths (a first indirect path and a second indirect path) according to various exemplary embodiments.

FIG. 1c shows a diagram of a third multi-path relay scenario for the remote UE comprising one direct path and two indirect paths (the first indirect path and the second indirect path according to various exemplary embodiments.

FIG. 2a shows a user plane (UP) protocol stack for the remote UE in the first multi-path relay scenario of Fig. 1a. according to various exemplary embodiments.

FIG. 2b shows a UP protocol stack for the relay UE in the first multi-path relay scenario of FIG. 1a according to various exemplary embodiments.

FIG. 2c shows a UP protocol stack for the gNB in the first multi-path relay scenario of FIG. 1a according to various exemplary embodiments.

FIG. 3a shows a diagram of a first scenario (Scenario 1) in which two indirect paths are configured with the same carrier for the two SLs (single carrier) according to various exemplary embodiments.

FIG. 3b shows a diagram of a second scenario (Scenario 2) in which two indirect paths are configured with the same carriers for the two SLs (multi-carrier) according to various exemplary embodiments.

FIG. 3c shows a diagram of a third scenario (Scenario 3) in which two indirect paths are configured with different carriers for the two SLs (single carrier) according to various exemplary embodiments.

FIG. 3d shows a diagram of a fourth scenario (Scenario 4) in which two indirect paths are configured with different carrier sets for the two SLS (multi-carrier) according to various exemplary embodiments.

FIG. 4 shows exemplary packet transmissions in various relay scenarios according to various exemplary embodiments.

FIG. 5a shows a UP protocol stack for a remote UE in the second multi-path relay scenario (Case 1) of FIG. 1b comprising two indirect paths according to various exemplary embodiments.

FIG. 5b shows a UP protocol stack for a remote UE in the third multi-path relay scenario (Case 2) of FIG. 1c comprising one direct path and two indirect paths according to various exemplary embodiments.

FIG. 6a shows a UP protocol stack for a remote UE in the second multi-path relay scenario (Case 1) of FIG. 1b comprising two indirect paths according to various exemplary embodiments.

FIG. 6b shows a UP protocol stack for a remote UE in the third multi-path relay scenario (Case 2) of FIG. 1c comprising one direct path and two indirect paths according to various exemplary embodiments.

FIG. 7a shows a signaling diagram for HARQ processes in a single relay SL scenario (one indirect path) according to various exemplary embodiments.

FIG. 7b shows a signaling diagram for HARQ processes in a two relay SL scenario (two indirect paths) implementing duplication with SL unicast according to various exemplary embodiments.

FIG. 7c shows a signaling diagram for HARQ processes in a two relay SL scenario (two indirect paths) implementing SL groupcast in which one ACK from either relay stops retransmissions of a packet to both relays according to various exemplary embodiments.

FIG. 8a shows a diagram in which two indirect paths are configured with different carriers according to various exemplary embodiments.

FIG. 8b shows a diagram in which two indirect paths are configured with different carriers according to various exemplary embodiments.

FIG. 9 shows a diagram including the UP protocol stacks of a remote UE and a relay UE according to various exemplary embodiments.

FIG. 10 shows an exemplary network arrangement according to various exemplary embodiments.

FIG. 11 shows an exemplary UE according to various exemplary embodiments.

FIG. 12 shows an exemplary base station according to various exemplary embodiments.

### DETAILED DESCRIPTION

The exemplary embodiments may be further understood with reference to the following description and the related appended drawings, wherein like elements are provided with the same reference numerals. The exemplary embodiments relate to operations for multi-path user equipment-to-network (U2N) relay communications including two or more indirect paths.

The exemplary embodiments are described with regard to a UE. However, the use of a UE is merely provided for illustrative purposes. The exemplary embodiments may be utilized with any electronic component that is configured with the hardware, software, and/or firmware to exchange information (e. g., control information) and/or data with the network. Therefore, the UE as described herein is used to represent any suitable electronic device.

The exemplary embodiments are also described with regard to a sidelink (SL). The term “sidelink” generally refers to a communication link between a first UE and a second UE. The SL can provide direct device-to-device (D2D) communication where information and/or data exchanged between the first UE and the second UE via the sidelink does not go through a cell. In some configurations, a single SL provides bidirectional data communication between the first UE and the second UE. In other configurations, a single SL provides unidirectional data communication between the UE and the further UE, although signaling may be transmitted in both directions. NR SL supports unicast communications (peer-to-peer transmissions/receptions), groupcast communications (transmissions/receptions among UEs in a group), and broadcast communications.

SL communications are supported by both Long-Term Evolution (LTE) and 5G new radio (NR) standards. In some configurations, the network may provide information to the UE that indicates how an SL is to be established, maintained and/or utilized. Thus, while the information and/or data exchanged over the SL does not go through a cell, the UE and the network may exchange information associated with the SL via the network cell. In other configurations, an SL is not under the control of the network. In either configuration, the first UE and the second UE may still perform synchronization procedures, discovery procedures and exchange control information corresponding to the SL.

The SL may be used for relay assistance to forward data/signals between a network and a remote UE that is out of range of the network and/or has poor network coverage. For example, a relay UE that is within range of the network and/or has good network coverage may relay data/signals between the network and the remote UE via the SL connection with the remote UE. A Layer 2 (L2) relay amplifies received signals to the destination after successful decoding/encoding and demodulation/modulation of the signals.

A typical network connection not employing the L2 relay may be referred to as a direct network path for the UE, while the L2 relay over SL may be referred to as an indirect network path for the (remote) UE. The direct path comprises a link between the UE and the gNB over the Uu interface. The indirect path comprises a sidelink between the remote UE and the relay UE over the PC5 interface and a link between the relay UE and the gNB over the Uu interface.

In Rel-18, multi-path communications comprising one direct path and one indirect path are to be supported. In future 3GPP releases (e.g., Rel-19), mechanisms and procedures may be supported for multi-path communications including two indirect paths, e.g., a first indirect path and a second indirect path, and more than two paths, e.g., one direct path and two or more indirect paths.

FIG. 1a shows a diagram 100 of a first multi-path relay scenario for a remote user equipment (UE) 102 comprising one direct path 110 and one indirect path 112. This scenario is to be supported in Rel-18. The direct path 110 comprises a direct connection between the remote UE 102 and a gNB 108 over the Uu interface; and the indirect path 112 comprises a sidelink 114 between the remote UE 102 and a relay UE 104 and a link 116 between the relay UE 104 and the gNB 108 for forwarding communications between the remote UE 102 and the gNB 108.

FIG. 1b shows a diagram 130 of a second multi-path relay scenario for the remote UE 102 comprising two indirect paths (a first indirect path 112 and a second indirect path 118). This scenario may be referred to herein as “Case 1” and may be supported in Rel-19. The first indirect path 112 comprises the sidelink 114 between the remote UE 102 and the relay UE 104 (relay UE1) and the link 116 between the relay UE 104 (relay UE1) and the gNB 108, as described in Fig. la; and the second indirect path 118 comprises a sidelink 120 between the remote UE 102 and a relay UE 106 (relay UE2) and a link 122 between the relay UE 106 (relay UE2) and the gNB 108.

FIG. 1c shows a diagram 140 of a third multi-path relay scenario for the remote UE 102 comprising one direct path 110 and two indirect paths (the first indirect path 112 and the second indirect path 118. This scenario may be referred to herein as “Case 2” and may be supported in Rel-19. It is noted that additional indirect paths (greater than two) may also be supported in Rel-19. The direct path 110 comprises the direct connection between the remote UE 102 and the gNB 108 over the Uu interface, as described above; the first indirect path 112 comprises the sidelink 114 between the remote UE 102 and the relay UE 104 (relay UE1) and the link 116 between the relay UE 104 (relay UE1) and the gNB 108, as described above; and the second indirect path 118 comprises the sidelink 120 between the remote UE 102 and the relay UE 106 (relay UE2) and the link 122 between the relay UE 106 (relay UE2) and the gNB 108, as described above.

The sidelink relay adaptation protocol (SRAP) refers to a sublayer introduced in Rel-17 for the layer 2 (L2) UE-to-network (U2N) relay and is specified in TS 38.351. The SRAP sublayer is located above the radio link control (RLC) layer and below the packet data convergence protocol (PDCP) layer. The packets received at the relay UE are opaque to the relay UE. In Rel-18, the multi-path design comprising one direct path and one indirect path, as shown in the scenario of FIG. 1a, will be introduced. In this design, the PDCP layer of the remote UE interfaces with one Uu RLC entity and one SRAP entity. The SRAP layer is used on the indirect path to indicate information about the end-to-end Uu RB (remote UE ID and bearer ID).

The SRAP data protocol data unit (PDU) comprises a SRAP header including a UE ID field and a bearer ID field. The UE ID field comprises 8 bits and carries a local identity of the remote UE in the L2 U2N relay operation, e. g., the remote UE 102 of FIG. 1a. The local ID is assigned by the network to distinguish amongst remote UEs. The bearer ID field comprises 5 bits and carries a Uu radio bearer identity for the remote UE.

The bearer ID is used to differentiate the end-to-end bearers between the same remote UE and network. The SRAP data PDU comprises the header and data packets, e.g., PDCP PDUs. The SRAP control PDU comprises the SRAP header only.

The configuration of the SRAP entity for the U2N relay UE includes the local identity for each U2N remote UE, a mapping from the UE ID field and bearer ID field to an egress Uu Relay RLC channel for each U2N remote UE, and a mapping from the UE ID field and bearer ID field to an egress PC5 Relay RLC channel for each U2N remote UE. The SRAP entity is configured via RRC.

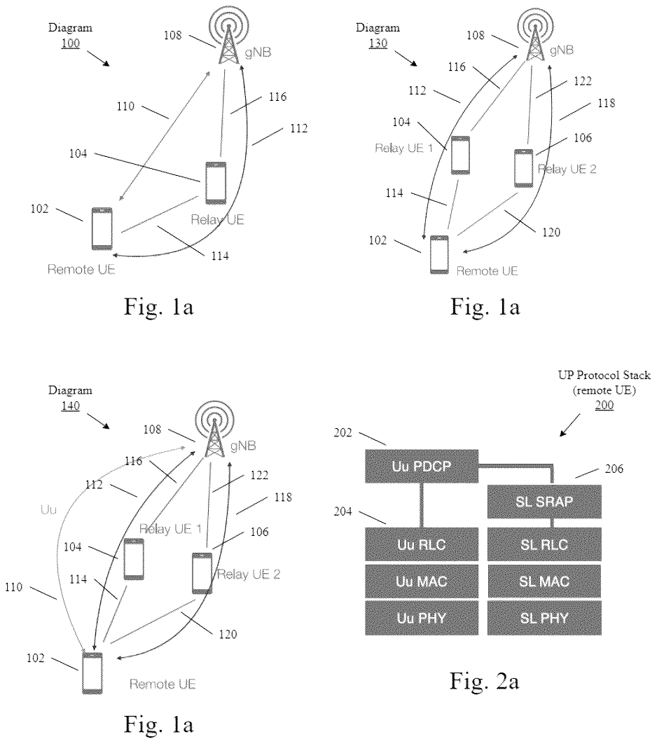

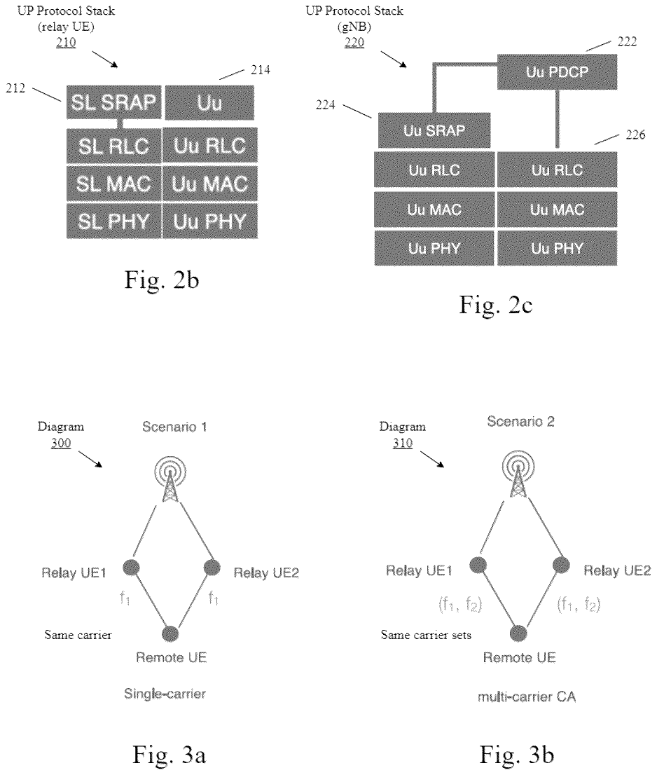

FIG. 2a shows a user plane (UP) protocol stack 200 for the remote UE 102 in the first multi-path relay scenario of Fig. la. A Uu PDCP entity 202 interfaces with both a Uu RLC entity 204 (for transmission/reception with the gNB 108 on the direct path) and a SL SRAP entity 206 (for transmission/reception with the relay UE 104 on the SL of the indirect path).

FIG. 2b shows a UP protocol stack 210 for the relay UE 104 in the first multi-path relay scenario of FIG. 1a. SL Tx/Rx with the remote UE 102 are encoded/decoded at a SL SRAP entity 212. The relay UE 104 communicates with the gNB 108 via a Uu stack 214.

FIG. 2c shows a UP protocol stack 220 for the gNB 108 in the first multi-path relay scenario of FIG. 1a. A Uu PDCP entity 222 interfaces with both a Uu RLC entity 224 (for transmission/reception with the remote UE 102 on the direct path) and a Uu SRAP entity 206 (for transmission/reception with the relay UE 104 on the Uu link of the indirect path).

By using two indirect paths, the robustness of the connection between the remote UE and the gNB can be increased. If one path fails, the traffic can be moved to another path.

Having two paths configured with different SL carriers may increase the UL/DL throughput for the remote UE. The reliability can be increased if the traffic is duplicated on both paths.

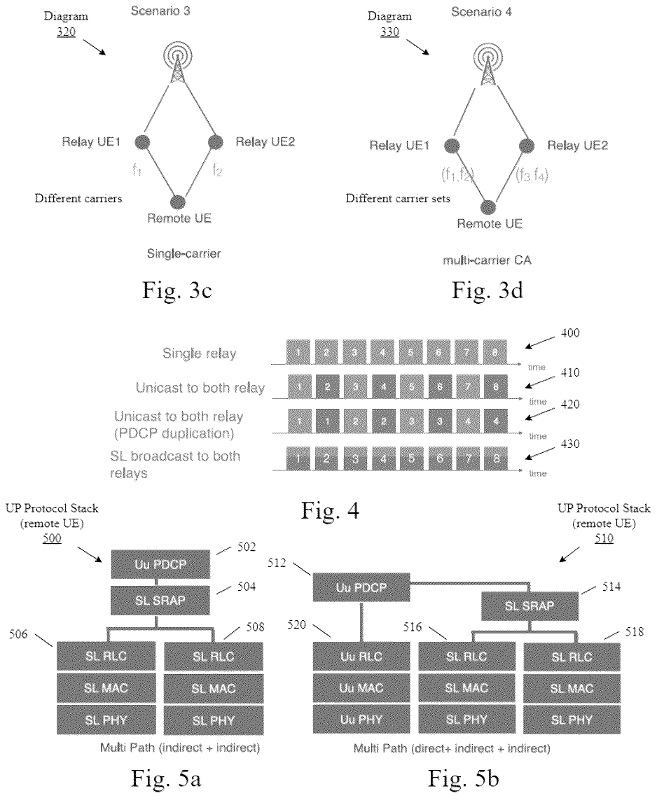

The following four scenarios are considered for multi-path communications comprising two indirect paths (including both Case 1 and Case 2 of FIGS. 1b-c above). FIGS. 3a-d show four diagrams for two indirect paths configured with: the same carrier for the two SLS (single carrier) (Scenario 1); the same carriers for the two SLs (multi-carrier) (Scenario 2); different carriers for the two SLs (single carrier) (Scenario 3) ; and different carrier sets for the two SLs (multi-carrier) (Scenario 4). These four scenarios will be considered in further detail below with regard to the exemplary embodiments described herein.

FIG. 3a shows a diagram 300 of a first scenario (Scenario 1) in which two indirect paths are configured with the same carrier for the two SLS (single carrier). In this example, the same carrier (f1) is configured for a first SL with a first relay UE and for a second SL with a second relay UE.

FIG. 3b shows a diagram 310 of a second scenario (Scenario 2) in which two indirect paths are configured with the same carriers for the two SLs (multi-carrier). In this example, the same carrier set (f1, f2) is configured for a first SL with a first relay UE and for a second SL with a second relay UE.

FIG. 3c shows a diagram 320 of a third scenario (Scenario 3) in which two indirect paths are configured with different carriers for the two SLs (single carrier). In this example, a first frequency (f1) is configured for the first SL with the first relay UE and a second frequency (f2) is configured for the second SL with the second relay UE.

FIG. 3d shows a diagram 330 of a fourth scenario (Scenario 4) in which two indirect paths are configured with different carrier sets for the two SLs (multi-carrier). In this example, a first frequency set (f1, f2) is configured for the first SL with the first relay UE and a second frequency set (f3, f4) is configured for the second SL with the second relay UE.

Three problems are identified herein with regard to Case 1 (two indirect paths) and/or Case 2 (one direct path and two (or more) indirect paths) and/or Scenarios 1-4 for Case 1/2. In a first problem, it is not specified how to determine the primary cell (PCell) in Case 1. In a second problem, for Case 1 Scenarios 1 and 2 (shown above in FIGS. 3a-b), when the same carrier(s) are used for both indirect paths, the path diversity does not provide throughput benefits. In a third problem, for Scenarios 2 and 4 (shown above in FIG. 3b, d), PDCP duplication for SL carrier aggregation cannot be used to increase the reliability of the PC5 hop because there is no PDCP entity involved in the transmission of the PC5 hop for relay traffic.

These three problems are discussed in further detail below and the exemplary embodiments are described with regard to solutions for these problems.

With regard to the first problem, in Rel-18 multi-path (one direct path and one indirect path), the PCell is always on the direct path. For Case 2 (one direct path and two (or more) indirect paths), the Rel-18 specification can be extended so that the PCell is always on the direct path. For Case 1 (two indirect paths), it is not specified how the UE is to determine which indirect path is a primary path (which cell is the PCell). The serving cells of the relay UE may be different, and the UE needs guidance to determine which cell is the PCell.

In one aspect of these exemplary embodiments, various options are considered for determining the PCell for Case 1 wherein a remote UE is configured with two indirect paths.

In one embodiment, the network can explicitly configure one indirect path to be the PCell path (or primary path) via RRC as part of the multi-path (MP) configuration.

In another embodiment, the PCell path can be determined implicitly via RRC. In one option, the network can configure a non-split SRB1 to be only on one path, which implicitly indicates the cell on this path to be the PCell. In another option, the network can configure a split SRB1 and send the multi-path configuration (RRCReconfiguration) on only one of the indirect paths, which implicitly indicates the cell on this path to be the PCell.

In another embodiment, the first indirect path added is always the PCell path. It is assumed that the PCell does not change when adding extra indirect path(s).

In a second problem, for using both indirect paths in the Case 1, Scenarios 1 and 2 (same carrier(s) for both SLS), there are no throughput improvements in the PC5 hop when SL unicast is used. The traffic transmitted via the first relay will contend with the traffic transmitted via the second relay.

FIG. 4 shows exemplary packet transmissions in various relay scenarios. In these examples, 8 individual packets can be transmitted on the available SL resources. The diagram 400 shows the SL resources in a single relay SL scenario (one indirect path) where the single relay is used to transmit all 8 packets. The diagram 410 shows the SL resources in a two relay SL unicast scenario where a first relay is used to transmit 4 packets (1, 3, 5 and 7) and a second relay is used to transmit 4 different packets (2, 4, 6 and 8) for a total transmission of 8 packets. The diagram 420 the SL resources in a two relay SL unicast with PDCP duplication scenario where a first relay is used to transmit 4 packets (1, 2, 3 and 4) and a second relay is used to transmit the same 4 (duplicated) packets (1, 2, 3 and 4) for a total transmission of 4 packets. The diagram 430 shows the SL resources in a two relay SL broadcast scenario where both the first and second relay are used to transmit all 8 packets.

As shown, the path diversity of two indirect paths does not provide throughput benefits relative to one indirect path. Using PDCP duplication in split bearer using both indirect paths will halve the end-to-end throughput. With regard to both throughput and reliability, PDCP duplication using both indirect paths is no better than using a single indirect path with retransmissions. For Scenarios 1 and 2, it is desirable to achieve higher throughput.

In another aspect of these exemplary embodiments, two alternative embodiments are described for transmitting/receiving traffic in multi-path scenarios comprising two or more indirect paths in view of design objectives including, e.g., higher throughput, lower latency, flexibility, etc.

In one embodiment, for each indirect path, a new SL RLC entity is created and the traffic is split among the multiple indirect paths by the PDCP layer. The traffic between the remote UE and each individual relay UE is still SL unicast. The gNB can configure the SRB/DRB for each indirect path in RRC. The gNB can configure a split DRB or a separate DRB for each path. It is possible to allow one DRB to use only the first indirect path and the other DRB to use only the second indirect path. The gNB can control the indirect path selection of the remote UE. The gNB can determine which indirect path to select based on measurement reports received from the remote UE. The gNB can steer the traffic to either or both of the indirect paths via RRC configuration. For example, the gNB can use an RRCReconfiguration message to configure an end-to-end Uu bearer between the remote UE and the gNB as a non-split bearer, so only one chosen indirect path is to be used by the remote UE for sending traffic of this end-to-end bearer to gNB. In another example, the gNB can configure the primary RLC entity of a split Uu bearer, so that only the indirect path corresponding to the primary RLC entity will be used for this end-to-end bearer, until the traffic amount threshold is reached. In these embodiments, the PC5 relay RLC Channels are configured for the remote UE and associated to a particular relay. As destination addresses (e.g., L2 IDs) are distinctive for the two SL relays, the remote UE will have RLC traffic towards different relays. In the examples provided below in FIGS. 5a-b two SL RLC entities are involved, however, it should be understood that additional SL RLC entities can be added for additional indirect paths (e.g., greater than 2).

FIG. 5a shows a protocol stack 500 for a remote UE in the second multi-path relay scenario (Case 1) of FIG. 1b comprising two indirect paths according to various exemplary embodiments. The remote UE has a Uu PDCP entity 502 above a SL SRAP entity 504. The SL SRAP entity 504 interfaces with a first SL RLC entity 506 and a second SL RLC entity 508. On the UL, the Uu PDCP entity 502 can control (based on RRC configuration) whether UL traffic is to be sent via the first SL RLC entity 506 or the second SL RLC entity 508. Based on the configuration, the UL traffic is supposed to be transported via the corresponding PC5 Relay RLC channel(s) between the remote UE and the relay UE of a L2 destination address on the chosen path, the SL SRAP entity 504 passes the UL traffic to one of the two SL RLC entities 506, 508 for transmission on their respective indirect paths and the MAC layer will append a proper MAC header with the L2 destination address matching the chosen relay UE.

FIG. 5b shows a protocol stack for a remote UE in the third multi-path relay scenario (Case 2) of FIG. 1c comprising one direct path and two indirect paths according to various exemplary embodiments. The remote UE has a Uu PDCP entity 512 above a Uu RLC entity 520 and a SL SRAP entity 514. The SL SRAP entity 514 interfaces with a first SL RLC entity 516 and a second SL RLC entity 518.

In another embodiment, SL traffic is broadcast/groupcast in the MAC layer for all the indirect paths using PC5 links. In these embodiments, a single SL RLC entity is used. SL unicast cannot be used in the single RLC entity architecture even if the MAC layer may be able to decide the indirect path selection for each MAC PDU dynamically. This is because one remote UE RLC entity cannot be successfully paired with two or more different RLC entities belonging to two or more different relay UEs. This is because the RLC header has a Sequence Number (SN) to track the Tx/Rx status between the TX RLC entity and Rx RLC entity and use that to trigger the RLC retransmission for RLC acknowledged mode (AM). If one TX entity is involved with more than one RX entity, the RLC SN will be out of sync between the remote UE and at least one of the relay UEs. Thus, only SL groupcast/broadcast in the PC5 hop can be enabled among relay UEs and remote UE, for both UL traffic and DL traffic or for UL traffic only. Only unidirectional unacknowledged mode (UM) is supported in SL groupcast/broadcast according to these exemplary embodiments, where there is no need of a 1 -to-1 relationship among GC/BC SL RLC entities.

In these embodiments, the gNB configures a multipath configuration common for all indirect paths via RRC, at least for UL traffic. For UL traffic, there is no differentiation on which RB is configured on which indirect path. For example, if DRB1 is configured on an indirect path, then DRB1 can use any or all of the indirect paths. To communicate with multiple relays, SL groupcast and broadcast are used with an RLC UM entity. SL groupcast provides better reliability/efficiency, as HARQ feedback (ACK/NACK) can be used. It is possible to use a single RLC entity for the traffic to reach both relays, as a common SL GC/BC Layer-2 destination address is used.

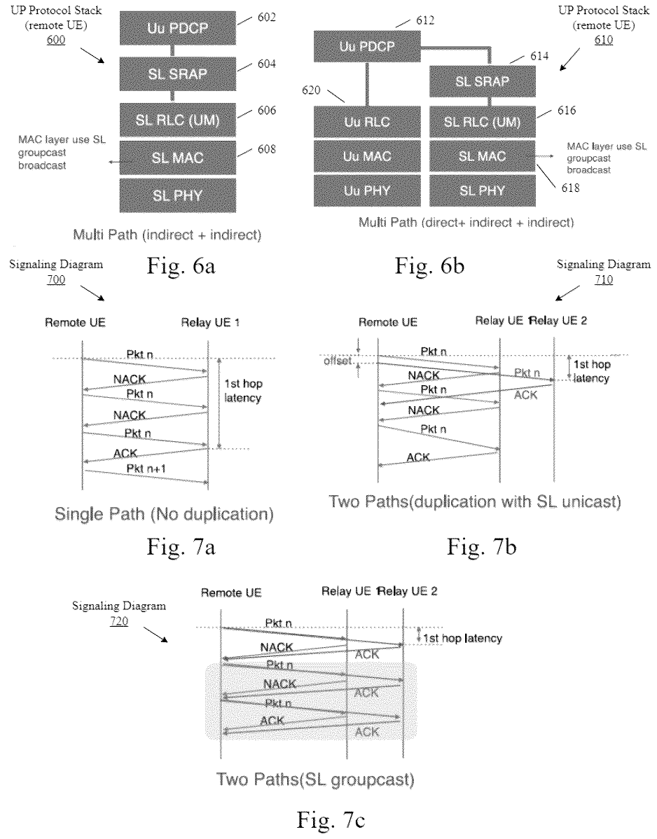

FIG. 6a shows a protocol stack 600 for a remote UE in the second multi-path relay scenario (Case 1) of FIG. 1b comprising two indirect paths according to further exemplary embodiments. The remote UE has a Uu PDCP entity 602 above a SL SRAP entity 604. The SL SRAP entity 604 interfaces with a single SL UM RLC entity 606. The SL UM RLC entity 606 interfaces with a SL MAC entity 608. The SL MAC entity 608 uses SL groupcast/broadcast.

FIG. 6b shows a protocol stack 610 for a remote UE in the third multi-path relay scenario (Case 2) of FIG. 1c comprising one direct path and two indirect paths according to further exemplary embodiments. The remote UE has a Uu PDCP entity 612 above a Uu RLC entity 620 and a SL SRAP entity 614. The SL SRAP entity 614 interfaces with a single SL UM RLC entity 616. The SL UM RLC entity 616 interfaces with a SL MAC entity 618. The SL MAC entity 618 uses SL groupcast/broadcast.

For the second alternative, the following options can be used. In the first option, both DL and UL can use GC/BC. Two separate L2 addresses can be specified (e.g., one for UL broadcast/groupcast, one for DL broadcast/groupcast). In one variant, a dedicated DL L2 address may not be specified and the L2 ID of the remote UE can be used as the DL groupcast/broadcast destination L2 ID. For DL broadcast/groupcast, the relay UE PC5 RLC entity will not listen to the DL L2 address, only remote UE need receive DL traffic.

In the second option, only the UL uses GC/BC and the DL still uses unicast. The remote UE maintains a unicast AM RLC entity and one broadcast/groupcast TX RLC entity. The relay UE maintains a unicast AM RLC entity and one broadcast/groupcast RX RLC entity. The relay UE can also filter the incoming GC/BC traffic from the remote UE with the Source L2 ID of the remote UE, so that it will not forward traffic not generated by the remote UE linked to this relay UE. This will be useful for the case where the relay UE may receive some GC/BC traffic from any UE-to-NW remote UEs, if all SL GC/BC for U2N relay shares a common L2 destination ID.

For the case when traffic is duplicated in both indirect paths (to exploit path diversity), there is no throughput/efficiency benefits from transmitting the same packet separately in both paths due to co-channel interference. However, there are some latency benefits because the transmission in the second indirect path may succeed earlier than the retransmission in the first indirect path, especially when the transmission occurs before the HARQ RTT timer expires in the HARQ process of the first indirect path. Although path diversity can reduce latency, the HARQ operation cannot be optimized to increase efficiency because different SL HARQ entities cannot coordinate to know that the same packet “n” (e. g., MAC SDU) has been already delivered in another path.

FIG. 7a shows a signaling diagram 700 for HARQ processes in a single relay SL scenario (one indirect path) according to one example. In this example, the packet n is transmitted from a remote UE to a relay UE. A NACK is received twice for the first two transmissions of the packet n and an ACK is received for the third transmission of the packet n. The latency for the first PC5 hop is equivalent to the time it takes for 2 retransmissions. After the ACK is received, the remote UE 702 transmits packet n+1.

FIG. 7b shows a signaling diagram 710 for HARQ processes in a two relay SL scenario (two indirect paths) implementing duplication with SL unicast according to another example of these exemplary embodiments. The packet n is transmitted from the remote UE to the relay UE (first relay UE) in the same manner as that of FIG. 7a (two retransmissions before receiving an ACK). In this example, the packet n is also transmitted from the remote UE to a second relay UE. An ACK is received for the first transmission of the packet n. The latency for the first PC5 hop is equivalent to the time it takes for an initial transmission (no retransmissions). Thus, the latency is reduced for the packet n. However, the packet n+1 is not transmitted until ACKs are received from both relay UEs.

In one aspect of these exemplary embodiments, SL groupcast HARQ can be optimized to skip retransmission if any one of the group members sends ACK. Thus, retransmissions on all indirect paths can be skipped if a single ACK is received from any group member.

FIG. 7c shows a signaling diagram 720 for HARQ processes in a two relay SL scenario (two indirect paths) implementing SL groupcast in which one ACK from either relay stops retransmissions of a packet to both relays according to another example of these exemplary embodiments. In this example, the packet n is transmitted from the remote UE to a first relay UE and a second relay UE, similar to FIG. 7b, and the ACK is received from the second relay UE. The retransmissions (shaded area) can be skipped, and the remote UE can proceed to transmit packet n+1.

The remote UE behavior for UL traffic can be described as follows for the Case 1 example. First, for a PDCP PDU, the SRAP header is added with UE ID and end-to-end bearer ID. Next, the SRAP PDU is passed to a SL RLC entity established for SL groupcast. Next, an L2 ID for relay groupcast is chosen as the destination address (e.g., for UL relay group only). Next, the remote UE generates the MAC PDU with RLC PDU(s). Next, the remote UE conducts resource selection. Next, the remote UE performs the groupcast transmission towards the relay UEs.

Next, the remote UE performs groupcast retransmission (if necessary) based on HARQ feedback (e. g., ACK/NACK).

With regard to Scenarios 2 and 4 described above, it is assumed that SL carrier aggregation (CA) is supported in 3GPP R18. Thus, we can consider the scenario that multiple relays are used for multi-carrier configuration, e.g., remote UE reaches relay UE1 via SL carrier f1, and relay UE2 via SL carrier f2, respectively. As long as there is no co-channel contention between the two sidelinks (remote UE-relay UE links), the throughput concern can be mitigated. The following options can be used for these scenarios.

In a first option, the remote UE uses two RLC AM or UM entities to reach each of the relay UEs using sidelink unicast. SL CA PDCP packet duplication is not applicable because PDCP duplication is between two SL PDCP entities and the L2 relay UE has no SL PDCP entity for end-to-end traffic. However, end-to-end CA PDCP duplication can be used.

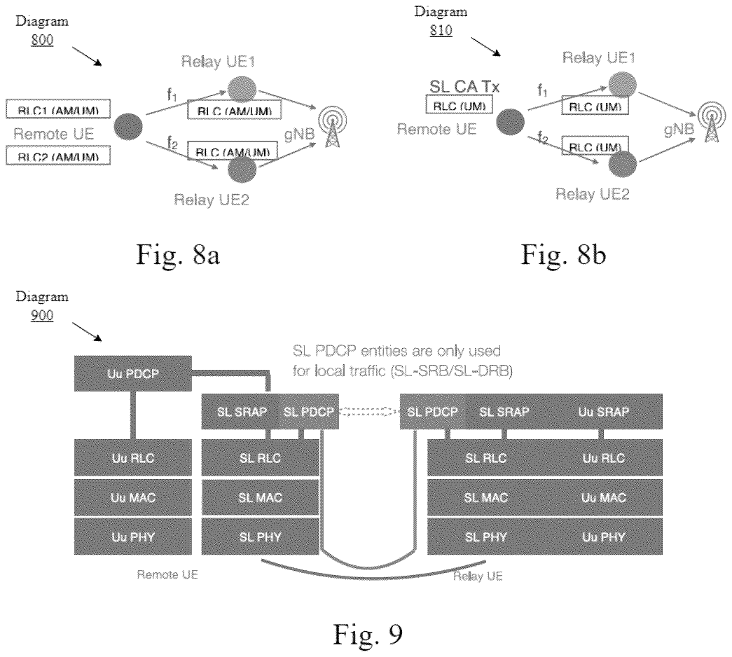

FIG. 8a shows a diagram 800 in which two indirect paths are configured with different carriers according to one embodiment. The remote UE includes two SL RLC entities (AM or UM). A first SL with the first relay UE is over a first carrier f1, and a second SL with the second relay UE is over a second carrier f2. Each relay UE has a SL RLC entity (AM or UM).

In a second option, the remote UE uses a single RLC UM entity to reach both of the relay UEs via SL broadcast/groupcast to the relay UEs. Sidelink Multi-carrier methods can be used as MAC layer multiplexing can still be done, as each relay UE only receives part of the SL groupcast traffic in a certain carrier sent by the remote UE for end-to-end UL traffic. However, this is equivalent to transmitting two separate SL MAC PDUs in two carriers respectively, and there are no throughput gains.

FIG. 8b shows a diagram 810 in which two indirect paths are configured with different carriers according to another embodiment. The remote UE includes one SL RLC entity (UM) and SL carrier aggregation is enabled for Tx. A first SL with the first relay UE is over a first carrier f1, and a second SL with the second relay UE is over a second carrier f2. Each relay UE has a SL RLC entity (UM).

Accordingly, the first option of these exemplary embodiments can be applied for scenarios 1-4 described above. The benefits for the first alternative include: duplicating the R18 legacy design from one indirect path to multiple indirect paths; and dynamic and flexibility usage of each indirect path by RRC configuration. However, there is no throughput performance improvement even with multiple indirect paths in single-carrier scenario; less improvement in reliability; throughput is further reduced if Uu PDCP duplication is adopted to enhance reliability.

The second option can be applied for scenarios 3-4 described above. The benefits for the second alternative include: no need to change the R18 RRC configuration; SL groupcast/broadcast provides enhanced throughput and reliability with path diversity; all indirect paths are treated as equal (at least for UL traffic). However, there is no differentiation of indirect paths and need upper layer specify a new L2 ID for GC/BC.

With regard to the third problem discussed above, PDCP packet duplication refers to a multi-connectivity solution for duplicating a PDCP PDU for transmission on multiple paths so that functions such as ciphering, header compression, etc. do not need to be performed twice. For Scenario 2 and Scenario 4, although more than one sidelink carrier is configured between a remote UE and a relay UE, the SL CA PDCP duplication cannot be used to increase the reliability of PC5 hop, because there is no SL PDCP entity involved in the transmission of PC5 hop for relay traffic. SL CA PDCP duplication can only be used for local, non-forwarding traffic between the remote UE and relay UE, but not relay traffic in multi-carrier configuration. It is desirable to include a solution to allow CA duplication in this case, so that reliability can be enhanced for the PC5 hop. Strictly, this is not a problem directly related to multiple indirect path issue, but since this is problem common to L2 U2N relay, which can be addressed in Rel-19 Relay enhancements.

FIG. 9 shows a diagram 900 including the UP protocol stacks of a remote UE and a relay UE. The SL PDCP entities in this example are used only for local traffic, e.g., SL-SRB or SL-DRB.

According to another aspect of these exemplary embodiments, sidelink CA PDCP duplication can be enabled in the SL SRAP layer instead of the SL PDCP layer. A sequence number (SN) can be introduced in the SRAP header so that duplicate SRAP PDUs received in different component carriers (CC) and the corresponding RLC entity can be detected. The SN enumerates the PDUs per end-to-end bearer and per UE ID.

As PQI (PC5 5QI) or 5QI is not visible to the relay UE, the SRAP entity in the relay UE can be configured by the network directly about whether the PC5 hop of each end-to-end Uu bearer can be SL CA duplicated or not. The network determines the reliability requirements in PC5 hop for an end-to-end bearer for the relay UE. If yes, then SRAP will have a duplicated PC5 relay RLC channel configured to transmit the SRAP PDU in two sets of carriers to improve the reliability of the PC5 hop.

For the remote UE, the “SL CA duplication or not” can be configured either by the network or by the remote UE itself based on the 5QIs of Uu traffic (and how it is reflected into the PC5 hop reliability). This configuration can be independent of the CA PDCP duplication for end-to-end Uu bearer.

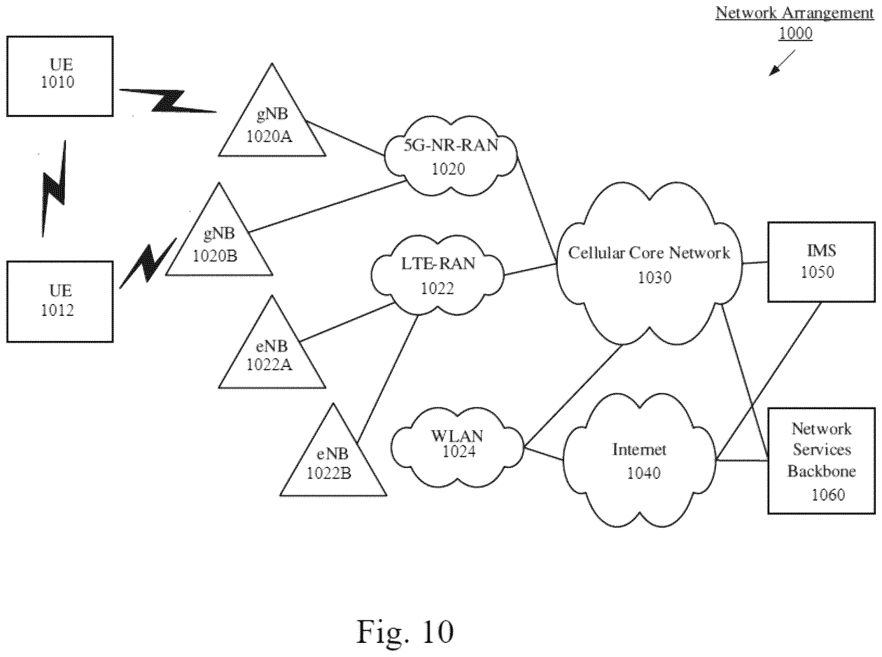

FIG. 10 shows an exemplary network arrangement 1000 according to various exemplary embodiments. The exemplary network arrangement 1000 include UEs 1010, 1012. Those skilled in the art will understand that the UEs 1010, 1012 may be any type of electronic component that is configured to communicate via a network, e.g., mobile phones, tablet computers, desktop computers, smartphones, phablets, embedded devices, wearables (e.g., HMD, AR glasses, etc.), Internet of Things (IoT) devices, etc. It should also be understood that an actual network arrangement may include any number of UEs being used by any number of users. Thus, the example of two UEs 1010, 1012 is merely provided for illustrative purposes.

The UEs 1010, 1012 may communicate directly with one or more networks. In the example of the network arrangement 1000, the networks with which the UEs 1010, 1012 may wirelessly communicate are a 5G NR radio access network (5G NR-RAN) 1020, an LTE radio access network (LTE-RAN) 1022 and a wireless local access network (WLAN) 1024. These types of networks support sidelink (SL) communication. In the exemplary network arrangement 1000, the UEs 1010 and 1012 may be connected via a SL. However, the UEs 1010, 1012 may also communicate with other types of networks and the UEs 1010, 1012 may also communicate with networks over a wired connection. Therefore, the UEs 1010, 1012 may include a 5G NR chipset to communicate with the 5G NR-RAN 1020, an LTE chipset to communicate with the LTE-RAN 1022 and an ISM chipset to communicate with the WLAN 1024.

The 5G NR-RAN 1020 and the LTE-RAN 1022 may be portions of cellular networks that may be deployed by a network carrier (e. g., Verizon, AT&T, T-Mobile, etc.) . These networks 1020, 1022 may include, for example, cells or base stations (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set. The WLAN 1024 may include any type of wireless local area network (WiFi, Hot Spot, IEEE 802.11x networks, etc.).

The UEs 1010, 1012 may connect to the 5G NR-RAN via the gNB 1020A or the gNB 1020B. Reference to two gNBs 1020A, 1020B is merely for illustrative purposes. The exemplary embodiments may apply to any appropriate number of gNBs. The UEs 1010, 1012 may also connect to the LTE-RAN 1022 via the eNBs 1022A, 1022B. Those skilled in the art will understand that any association procedure may be performed for the UEs 1010, 1012 to connect to the 5G NR-RAN 1020 and the LTE-RAN 1022. For example, as discussed above, the 5G NR-RAN 1020 and the LTE-RAN 1022 may be associated with a particular cellular provider where the UEs 1010, 1012 and/or the user thereof has a contract and credential information (e.g., stored on a SIM card). Upon detecting the presence of the 5G NR-RAN 1020, the UEs 1010, 1012 may transmit the corresponding credential information to associate with the 5G NR-RAN 1020. More specifically, the UEs 1010, 1012 may associate with a specific base station (e.g., the gNB 1020A of the 5G NR-RAN 1020, the eNB 1022A of the LTE-RAN 1022).

The UEs 1010, 1012 may also communicate with one another directly using a SL. The SL is a direct device-to-device (D2D) communication link. Thus, the information and/or data transmitted directly to the other endpoint (e.g., the UE 1010 or the UE 1012) does not go through a cell (e. g., qNB 1020A, eNB 1022A). In some embodiments the UEs 1010, 1012 may receive information from a cell regarding how the SL is to be established, maintained and/or utilized. Thus, a network (e.g., the 5G NR-RAN 1020, LTE-RAN 1022) may control the SL. In other embodiments, the UEs 1010, 1012 may control the SL. Regardless of how the SL is controlled, the UEs 1010, 1012 may maintain a downlink/uplink to a currently camped cell (e.g., gNB 1020A, eNB 1022A) and a SL to the other UE simultaneously.

In some scenarios, a UE, e.g., the UE 1010, may not have a direct connection with a cell and may use a further UE, e.g., the UE 1012, as a relay UE to forward data/signals to/from the UE 1010 and/or the 5G NR-RAN 1020. The SL may be used for relay assistance to forward data/signals between the 5G NR-RAN 1020 and the remote UE 1010 that is out of range of the network and/or has poor network coverage. A Layer 2 (L2) UE to network (U2N) relay amplifies received signals to the destination after successful decoding/encoding and demodulation/modulation of the signals.

In addition to the networks 1020, 1022 and 1024 the network arrangement 1000 also includes a cellular core network 1030, the Internet 1040, an IP Multimedia Subsystem (IMS) 1050, and a network services backbone 1060. The cellular core network 1030 may be considered to be the interconnected set of components that manages the operation and traffic of the cellular network. The cellular core network 1030 also manages the traffic that flows between the cellular network and the Internet 1040. The IMS 1050 may be generally described as an architecture for delivering multimedia services to the UEs 1010, 1012 using the IP protocol. The IMS 1050 may communicate with the cellular core network 1030 and the Internet 1040 to provide the multimedia services to the UEs 1010, 1012. The network services backbone 1060 is in communication either directly or indirectly with the Internet 1040 and the cellular core network 1030. The network services backbone 1060 may be generally described as a set of components (e.g., servers, network storage arrangements, etc.) that implement a suite of services that may be used to extend the functionalities of the UEs 1010, 1012 in communication with the various networks.

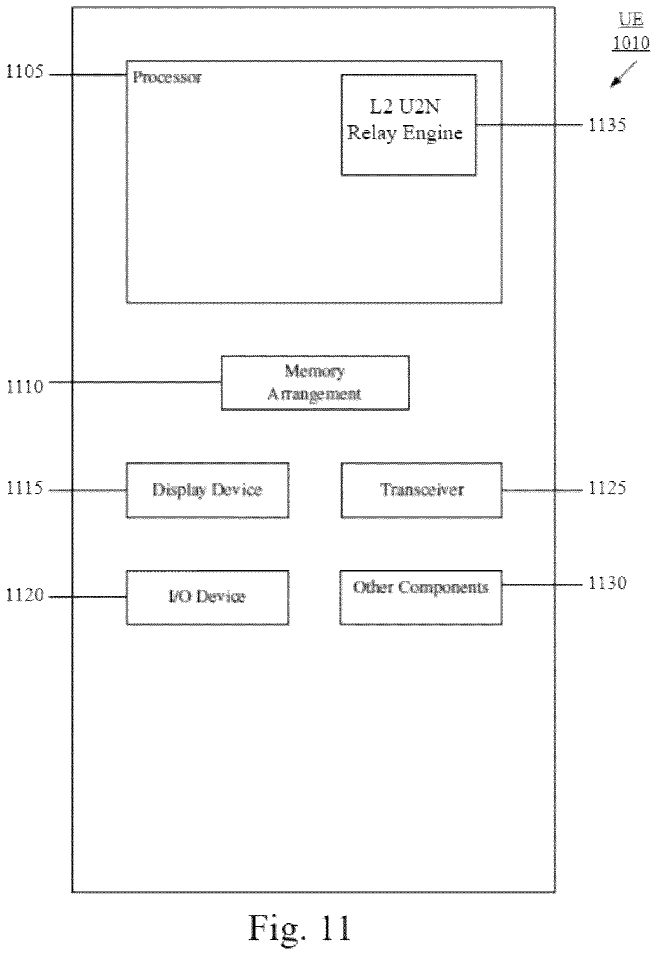

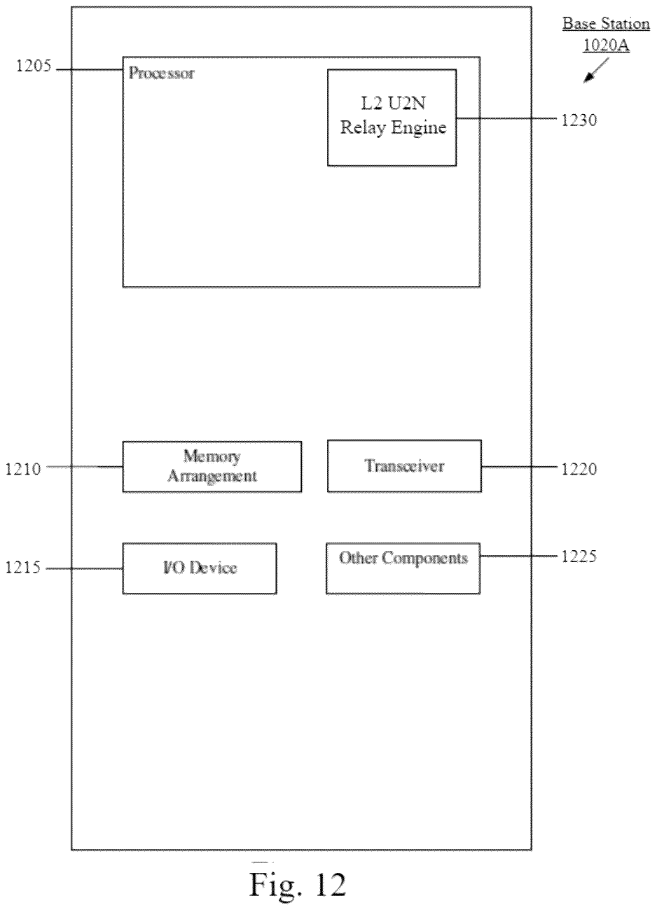

FIG. 11 shows an exemplary UE 1010 according to various exemplary embodiments. The UE 1010 will be described with regard to the network arrangement 1000 of FIG. 10. The UE 1010 may also represent any of the UEs 102-110 described above with respect to FIGS. 1-4. The UE 1010 may include a processor 1105, a memory arrangement 1110, a display device 1115, an input/output (I/O) device 1120, a transceiver 1125 and other components 1130. The other components 1130 may include, for example, an audio input device, an audio output device, a power supply, a data acquisition device, ports to electrically connect the UE 1010 to other electronic devices, etc.

The processor 1105 may be configured to execute a plurality of engines of the UE 1010. For example, the engines may include an L2 U2N relay engine 1135 for performing various operations related to multi-path L2 relay operations comprising multiple indirect paths, as described above.

The above referenced engine 1135 being an application (e.g., a program) executed by the processor 1105 is provided merely for illustrative purposes. The functionality associated with the engine 1135 may also be represented as a separate incorporated component of the UE 1010 or may be a modular component coupled to the UE 1010, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 1105 is split among two or more processors such as a baseband processor and an applications processor. The exemplary embodiments may be implemented in any of these or other configurations of a UE.

The memory arrangement 1110 may be a hardware component configured to store data related to operations performed by the UE 1010. The display device 1115 may be a hardware component configured to show data to a user while the I/O device 1120 may be a hardware component that enables the user to enter inputs. The display device 1115 and the I/O device 1120 may be separate components or integrated together such as a touchscreen. The transceiver 1125 may be a hardware component configured to establish a connection with the 5G NR-RAN 1020 and/or any other appropriate type of network. Accordingly, the transceiver 1125 may operate on a variety of different frequencies or channels (e.g., set of consecutive frequencies).

FIG. 12 shows an exemplary base station 1020A according to various exemplary embodiments. The base station 1020A will be described with regard to the network arrangement 1000 of FIG. 10. The base station 1020A may represent any access node through which the UE 1010 may establish a connection and manage network operations. The base station 1020A may also represent the base station 1020B of FIG. 10 or the gNBs 108 described above with respect to FIGS. 1-4.

The base station 1020A may include a processor 1205, a memory arrangement 1210, an input/output (I/O) device 1215, a transceiver 1220, and other components 1225. The other components 1225 may include, for example, a battery, a data acquisition device, ports to electrically connect the base station 1020A to other electronic devices, etc.

The processor 1205 may be configured to execute a plurality of engines of the base station 1020A. For example, the engines may include an L2 U2N relay engine 1230 for performing various operations related to multi-path L2 relay operations comprising multiple indirect paths, as described above.

The above noted engine 1230 being an application (e.g., a program) executed by the processor 1205 is only exemplary. The functionality associated with the engine 1230 may also be represented as a separate incorporated component of the base station 1020A or may be a modular component coupled to the base station 1020A, e.g., an integrated circuit with or without firmware. For example, the integrated circuit may include input circuitry to receive signals and processing circuitry to process the signals and other information. In addition, in some base stations, the functionality described for the processor 1205 is split among a plurality of processors (e.g., a baseband processor, an applications processor, etc.) . The exemplary embodiments may be implemented in any of these or other configurations of a base station.

The memory 1210 may be a hardware component configured to store data related to operations performed by the base station 1020A. The I/O device 1215 may be a hardware component or ports that enable a user to interact with the base station 1020A. The transceiver 1220 may be a hardware component configured to exchange data with the UE 1010 and any other UE in the network arrangement 1000. The transceiver 1220 may operate on a variety of different frequencies or channels (e.g., set of consecutive frequencies). Therefore, the transceiver 1220 may include one or more components (e.g., radios) to enable the data exchange with the various networks and UEs.

### EXAMPLES

In a first example, a method performed by a user equipment (UE), comprising receiving a radio resource control (RRC) configuration for UE-to-network (U2N) relay operations including at least two indirect paths, wherein a first indirect path is configured with a first relay UE via a first sidelink (SL) and a second indirect path is configured with a second relay UE via a second SL and determining a primary path as either the first indirect path or the second indirect path.

In a second example, the method of the first example, further comprising receiving an explicit RRC configuration for the primary path as either the first indirect path or the second indirect path.

In a third example, the method of the first example, further comprising receiving a configuration for a non-split signaling radio bearer (SRB) 1 (SRB1) on the first indirect path and not receiving a configuration for SRB1 on the second indirect path, wherein the first indirect path is determined to be the primary path based on at least the configuration for the non-split SRB1.

In a fourth example, the method of the first example, further comprising receiving a configuration on the first indirect path for a split signaling radio bearer (SRB) 1 (SRB1) and not receiving a configuration for SRB1 on the second indirect path, wherein the first indirect path is determined to be the primary path based on at least the configuration for the split SRB1.

In a fifth example, the method of the first example, wherein determining the primary path comprises determining a first one added of the first indirect path or the second indirect path, wherein the first one added is determined to be the primary path.

In a sixth example, a processor of a user equipment (UE) configured to perform any of the methods of the first through fifth examples.

In a seventh example, a user equipment (UE) comprising a transceiver configured to communicate with a first relay UE using a first sidelink (SL) and a second relay UE using a second SL and a processor communicatively coupled to the transceiver and configured to perform any of the methods of the first through fifth examples.

In an eighth example, a method performed by a user equipment (UE), comprising receiving a radio resource control (RRC) configuration for UE-to-network (U2N) relay operations including at least two indirect paths wherein a first indirect path is configured with a first relay UE via a first sidelink (SL) and a second indirect path is configured with a second relay UE via a second SL, the RRC configuration including a first radio link control (RLC) entity associated with the first relay UE and a second RLC entity associated with the second relay UE and selecting either the first indirect path or the second indirect path for uplink (UL) traffic by indicating an identifier for either the first relay UE or the second relay UE in a packet data convergence protocol (PDCP) header added by a PDCP entity.

In a ninth example, the method of the eighth example, wherein the first and second RLC entities interface with a single SL sidelink relay adaptation protocol (SRAP) entity beneath the PDCP entity.

In a tenth example, a processor of a user equipment (UE) configured to perform any of the methods of the eighth or ninth examples.

In an eleventh example, a user equipment (UE) comprising a transceiver configured to communicate with a first relay UE using a first sidelink (SL) and a second relay UE using a second SL and a processor communicatively coupled to the transceiver and configured to perform any of the methods of the eighth or ninth examples.

In a twelfth example, a method performed by a user equipment (UE), comprising receiving a radio resource control (RRC) configuration for UE-to-network (U2N) relay operations including at least two indirect paths wherein a first indirect path is configured with a first relay UE via a first sidelink (SL) and a second indirect path is configured with a second relay UE via a second SL, the RRC configuration including a common configuration for both the first and second indirect paths and using SL groupcast operations or SL broadcast operations by a single SL radio link control (RLC) entity to transmit packets to the first and second relay UEs.

In a thirteenth example, the method of the twelfth example, wherein the RLC entity is in unacknowledged mode (UM).

In a fourteenth example, the method of the thirteenth example, wherein the RLC entity is only for transmission on an uplink (UL) and SL unicast operations are configured for a downlink (DL).

In a fifteenth example, the method of the twelfth example, wherein the SL groupcast operations or SL broadcast operations are configured for both a downlink (DL) and an uplink (UL).

In a sixteenth example, the method of the fifteenth example, wherein a layer 2 (L2) address is configured for both UL and DL.

In a seventeenth example, the method of the fifteenth example, wherein a layer 2 (L2) address is configured for UL and an L2 identifier for the UE is used for DL.

In an eighteenth example, the method of the twelfth example, further comprising receiving a configuration in which, if an acknowledgement (ACK) is received from either the first relay UE or the second relay UE for a transmitted packet, retransmissions of the transmitted packet are stopped for both indirect paths.

In a nineteenth example, a processor of a user equipment (UE) configured to perform any of the methods of the twelfth through eighteenth examples.

In a twentieth example, a user equipment (UE) comprising a transceiver configured to communicate with a first relay UE using a first sidelink (SL) and a second relay UE using a second SL and a processor communicatively coupled to the transceiver and configured to perform any of the methods of the twelfth through eighteenth examples.

In a twenty first example, a method performed by a user equipment (UE), comprising receiving a radio resource control (RRC) configuration for UE-to-network (U2N) relay operations including an indirect path, wherein the indirect path is configured with a relay UE via a sidelink (SL), the RRC configuration including an indication of whether carrier aggregation (CA) duplication in a sidelink relay adaptation protocol (SRAP) layer is enabled and when CA duplication in the SRAP layer is enabled, adding a sequence number (SN) in a SRAP header so that duplicate SRAP protocol data units (PDUs) received in different component carriers can be detected.

In a twenty second example, a processor of a user equipment (UE) configured to perform the method of the twenty first example.

In a twenty third example, a user equipment (UE) comprising a transceiver configured to communicate with a relay UE using a sidelink (SL) and a processor communicatively coupled to the transceiver and configured to perform the method of the twenty first example.

In a twenty fourth example, a method performed by a user equipment (UE), comprising receiving a radio resource control (RRC) configuration for UE-to-network (U2N) relay operations including an indirect path in which the UE is a relay UE for a remote UE via a sidelink (SL) and using SL groupcast operations or SL broadcast operations by a SL radio link control (RLC) entity to transmit packets to and receive packets from the remote UE.

In a twenty fifth example, the method of the twenty fourth example, wherein the RLC entity is in unacknowledged mode (UM).

In a twenty sixth example, the method of the twenty fifth example, wherein the SL groupcast operations or SL broadcast operations is only for transmission on an uplink (UL) of the remote UE and SL unicast operations are configured for a downlink (DL) of the remote UE, wherein the UE maintains an acknowledged mode (AM) RLC entity for transmissions to the remote UE and an UM RLC entity for receptions from the remote UE.

In a twenty seventh example, the method of the twenty sixth example, wherein the UE filters the receptions from the remote UE using a layer 2 (L2) identifier of the remote UE.

In a twenty eighth example, the method of the twenty fourth example, wherein the SL groupcast operations or SL broadcast operations are configured for both a downlink (DL) and an uplink (UL).

In a twenty ninth example, the method of the twenty eighth example, wherein a layer 2 (L2) address is configured for both UL and DL.

In a thirtieth example, the method of the twenty eighth example, wherein a layer 2 (L2) address is configured for UL and an L2 identifier for the remote UE is used for DL.

In a thirty first example, a processor of a user equipment (UE) configured to perform any of the methods of the twenty fourth through thirtieth examples.

In a thirty second example, a user equipment (UE) comprising a transceiver configured to communicate with a remote UE using a sidelink (SL) and a processor communicatively coupled to the transceiver and configured to perform any of the methods of the twenty fourth through thirtieth examples.

In a thirty third example, a method performed by a user equipment (UE), comprising receiving a radio resource control (RRC) configuration for UE-to-network (U2N) relay operations including an indirect path in which the UE is a relay UE for a remote UE via a sidelink (SL), the RRC configuration including an indication of whether carrier aggregation (CA) duplication in a sidelink relay adaptation protocol (SRAP) layer is enabled and when CA duplication in the SRAP layer is enabled, receiving a duplicate SRAP protocol data unit (PDUs) including a sequence number (SN) in a SRAP header.

In a thirty fourth example, a processor of a user equipment (UE) configured to perform the method of the thirty third example.

In a thirty fifth example, a user equipment (UE) comprising a transceiver configured to communicate with a remote UE using a sidelink (SL) and a processor communicatively coupled to the transceiver and configured to perform the method of the thirty third example.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, etc. In a further example, the exemplary embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalents.

1. A method performed by a user equipment (UE), comprising:
receiving a radio resource control (RRC) configuration for UE-to-network (U2N) relay operations including at least two indirect paths, wherein a first indirect path is configured with a first relay UE via a first sidelink (SL) and a second indirect path is configured with a second relay UE via a second SL; and
determining a primary path as either the first indirect path or the second indirect path.

2. The method of claim 1, further comprising:
receiving an explicit RRC configuration for the primary path as either the first indirect path or the second indirect path.

3. The method of claim 1, further comprising:
receiving a configuration for a non-split signaling radio bearer (SRB) 1 (SRB1) on the first indirect path and not receiving a configuration for SRB1 on the second indirect path, wherein the first indirect path is determined to be the primary path based on at least the configuration for the non-split SRB1.

4. The method of claim 1, further comprising:
receiving a configuration on the first indirect path for a split signaling radio bearer (SRB) 1 (SRB1) and not receiving a configuration for SRB1 on the second indirect path, wherein the first indirect path is determined to be the primary path based on at least the configuration for the split SRB1.

5. The method of claim 1, wherein determining the primary path comprises: determining a first one added of the first indirect path or the second indirect path, wherein the first one added is determined to be the primary path.

6. A method performed by a user equipment (UE), comprising:
receiving a radio resource control (RRC) configuration for UE-to-network (U2N) relay operations including at least two indirect paths wherein a first indirect path is configured with a first relay UE via a first sidelink (SL) and a second indirect path is configured with a second relay UE via a second SL, the RRC configuration including a first radio link control (RLC) entity associated with the first relay UE and a second RLC entity associated with the second relay UE; and
selecting either the first indirect path or the second indirect path for uplink (UL) traffic by indicating an identifier for either the first relay UE or the second relay UE in a packet data convergence protocol (PDCP) header added by a PDCP entity.

7. The method of claim 6, wherein the first and second RLC entities interface with a single SL sidelink relay adaptation protocol (SRAP) entity beneath the PDCP entity.

8. A method performed by a user equipment (UE), comprising:
receiving a radio resource control (RRC) configuration for UE-to-network (U2N) relay operations including at least two indirect paths wherein a first indirect path is configured with a first relay UE via a first sidelink (SL) and a second indirect path is configured with a second relay UE via a second SL, the RRC configuration including a common configuration for both the first and second indirect paths; and
using SL groupcast operations or SL broadcast operations by a single SL radio link control (RLC) entity to transmit packets to the first and second relay UEs.

9. The method of claim 8, wherein the RLC entity is in unacknowledged mode (UM).

10. The method of claim 9, wherein the RLC entity is only for transmission on an uplink (UL) and SL unicast operations are configured for a downlink (DL).

11. The method of claim 8, wherein the SL groupcast operations or SL broadcast operations are configured for both a downlink (DL) and an uplink (UL).

12. The method of claim 11, wherein a layer 2 (L2) address is configured for both UL and DL.

13. The method of claim 11, wherein a layer 2 (L2) address is configured for UL and an L2 identifier for the UE is used for DL.

14. The method of claim 8, further comprising:
receiving a configuration in which, if an acknowledgement (ACK) is received from either the first relay UE or the second relay UE for a transmitted packet, retransmissions of the transmitted packet are stopped for both indirect paths.

15. (canceled)
